(19) United States
(12) Patent Application Publication
(10) Pub. No.: US 2007/0050289 A1
(43) Pub. Date: Mar. 1, 2007

(54) System for processing non-prime credit applications

(75) Inventors: Michael Zeller, San Diego, CA (US); Alex Guazzelli, San Diego, CA (US)

Correspondence Address: HOGAN & HARTSON L.L.P., 1999 AVENUE OF THE STARS, SUITE 1400, LOS ANGELES, CA, 90067, US

(73) Assignee: ZEMENTIS, INC.

(21) Appl. No.: 11/228,665

(22) Filed: Sep. 15, 2005

(51) Int. Cl. G06Q 40/00

(52) U.S. Cl. 705/38

(57) ABSTRACT

A system for processing credit applications. An adaptive decision engine produces a score determined by the risk associated with a credit application. The credit application is automatically approved or rejected if the score is above or below certain thresholds, and is otherwise referred for manual processing. The system may include a rules system that automatically approves applications if all conditions are met, and generates exceptions if all conditions are not met and refers the application to the adaptive decision engine for further processing. A decision to approve or reject an application may be based on a combination of the risk score and number of exceptions.

### FIELD OF THE INVENTION

The present invention relates to a system for processing credit applications in the non-prime market.

### BACKGROUND OF THE INVENTION

In the financial industry, credit applications for non-prime applicants are typically processed manually. A typical manual workflow for processing credit applications is depicted in FIG. 1. A credit applicant 1 prepares numerous credit application papers and/or electronic forms, which are then submitted to a bank, a lender or, as is frequently the case in the non-prime mortgage industry, a broker 2. Broker 2 may help applicant 1 prepare the application forms to facilitate approval of the credit application. When the application is complete, broker 2 sends it to a loan officer 3 of a potential lender. Based on the internal guidelines of the lender, loan officer 3 decides whether to approve or reject the application. If the application is approved, it continues in the lender's workflow to loan origination system 4.

FIG. 2 illustrates an alternative, partially automated workflow used by some lenders. Most lenders ask for very similar information about the applicant(s) to determine the risk of a credit application. Hence, software systems have been developed to enable automatic underwriting 5. These systems typically rely on recent data standards, such as Fannie Mae 1003 and MISMO, that facilitate efficient data exchange between the different stakeholders of the transaction. For example, broker 2 may electronically submit the applicant's information to the lender either through a local program residing on a personal computer or directly through an Internet portal. In either case, the information is submitted to the lender's automatic underwriting system 5, which enables the lender to process certain conforming loans automatically.

Some lenders have deployed rule-based guidelines 6, typically implemented in software, which determine whether an application conforms to the lender's guidelines. For example, a rule may determine whether the loan originates in a state where the lender has a license to operate. Over time, lenders have implemented more comprehensive rules and systems are now able to automatically approve credit applications for the prime and non-prime market if all conditions associated with a loan product are satisfied. However, credit applications which do not fit into the exact requirements of a certain loan product are either rejected or referred for manual processing by a loan officer.

In fact, many credit applications, especially in the non-prime market, do not meet all conditions expressed in a rules-based system and must be manually processed. Some lenders resort to implementing more complex rules, so that a larger percentage of submitted applications can be automatically approved. However, in the non-prime market, most credit applications have at least one exception that presents a rules-based system with a difficult challenge. More complex rule sets partially alleviate this problem but still capture only a small percentage of presented applications. Consequently, rules-based systems have become more complicated and the vast majority of credit applications in the non-prime market must still be processed manually. A typical rules-based system for the non-prime market may implement hundreds or even thousands of rules which are needed to cope with the complexity of the credit decisions. The maintenance of such systems is extremely complex, cumbersome, and error-prone. Even when such a system is implemented and properly maintained, a significant number of credit applications still fall outside of the defined rules set and must be processed manually.

In addition to the mortgage industry and non-prime credit applications with complex approval requirements, this problem also exists in auto finance, credit card, Home Equity Line Of Credit (HELOC) and other credit lines.

### SUMMARY OF THE INVENTION

One embodiment of the invention is a system for processing credit applications comprising a computer-implemented adaptive decision engine that produces a score determined by the risk associated with a credit application. In one implementation, credit applications are automatically approved or rejected, or referred for manual processing, based on a comparison of the risk score with predetermined thresholds.

Another embodiment of the invention is a method for processing credit applications. A risk score associated with a credit application is calculated, and the credit application is automatically approved or rejected based on a comparison of the risk score with at least one predetermined threshold.

Another embodiment of the invention is a computer program product stored in a tangible computer-readable medium. The computer program product includes an adaptive decision engine that produces a score determined by the risk associated with a credit application. A rules system automatically approves the credit application if all conditions are met, and refers the application to the adaptive decision engine for further risk assessment if conditions are not met.

These and other embodiments of the invention are described in more detail in the following description, drawings and claims.

### BRIEF DESCRIPTION OF THE DRAWINGS

FIG. 1 is a flow diagram depicting a conventional method for processing credit applications.

FIG. 2 is a flow diagram depicting an alternative conventional method for processing credit applications.

FIG. 3 is a flow diagram of a method for processing credit applications according to the present invention.

FIG. 4a is a diagram illustrating use of risk thresholds by the method of the present invention.

FIG. 4b is a diagram illustrating use of risk thresholds by the method of the present invention.

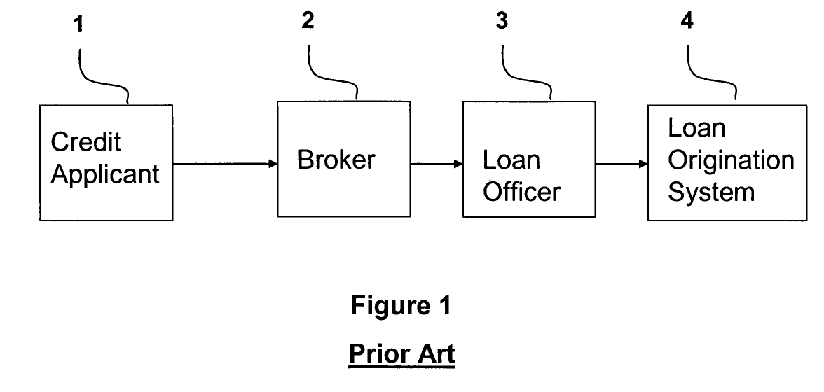

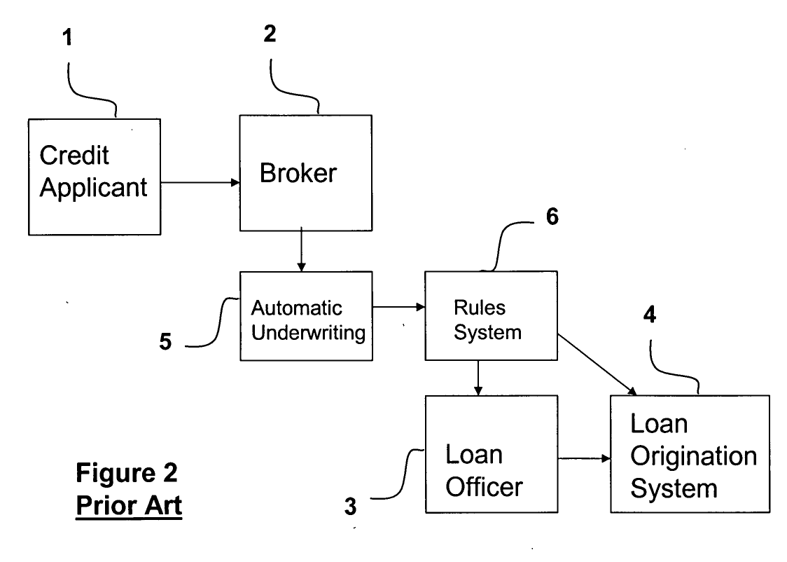

### DETAILED DESCRIPTION OF THE INVENTION

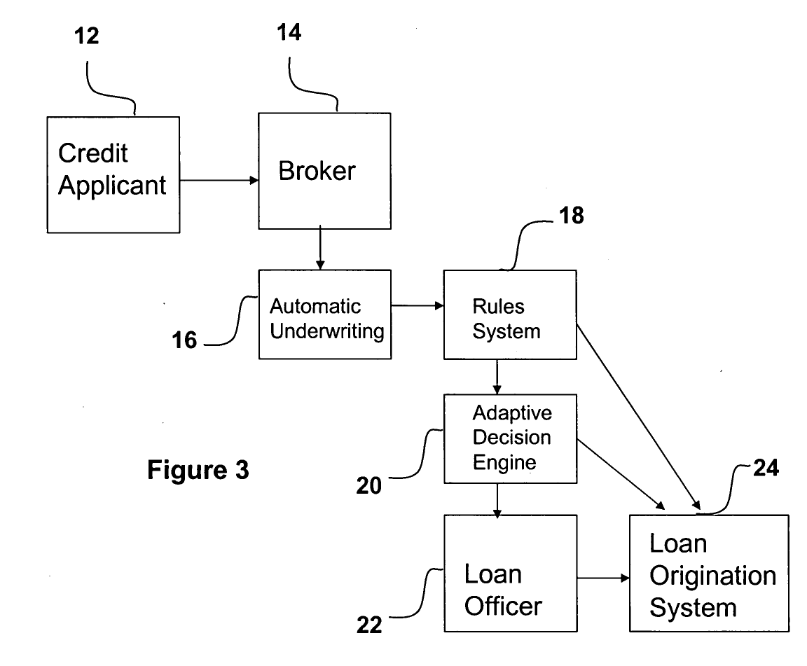

FIG. 3 illustrates a method for processing credit applications according to the present invention. The credit applications may be, for example, loan applications for mortgages, auto finance, Home Equity Line Of Credit, credit cards or bank account lines of credit.

Credit applicant 12, with the assistance of broker 14, has a credit application prepared and submitted to automatic underwriting system 16. Alternatively, applicant 12 may submit an application directly to automatic underwriting system 16, in which case broker 14 may be eliminated. The submission of the application may take place either through the Internet or via a dedicated connection. Broker 14 may also enter the application data directly into system 16, such as through an Internet portal.

Once the credit application is entered into automated underwriting system 16, rules system 18 checks the application for exceptions. System 18 either (1) rejects the loan (for example, if the lender is not licensed in the state of interest); (2) approves the loan if all conditions are met and enters it into loan origination system 24; or (3) refers the application to adaptive decision engine 20 if not all conditions are met as stated in rules system 18. Adaptive decision engine 20 checks if the exceptions, generated when conditions were not met, can be automatically waived. This is a balance between how many exceptions are waived and the perceived risk of a loan. The number of exceptions does not necessarily reflect the actual risk level associated with a credit application since it may contain enough compensating factors to offset the risk posed by failed conditions. For example, while an exception may state that the credit history of the applicant is not good enough for a certain loan product, the same applicant may be able to show that he/she is working in a stable job that pays well. The applicant's job status may then be used to compensate for the bad credit history.

Adaptive decision engine 20 may be a computer program implemented in computer hardware or software. The core of decision engine 20 is a predictive algorithm that is presented with credit application characteristics from historical data. Once trained, decision engine 20 is able to discriminate between high and low risk applications. Predictive algorithms that may be used by adaptive decision engine 20 to estimate the risk of an application include, without limitation, artificial neural networks, statistical algorithms such as linear and logistic regression, fuzzy logic, genetic algorithms, decision trees, or any other algorithm that is able to extract knowledge from data, i.e., data-driven algorithms. Adaptive decision engine 20 may also leverage predictive models, historical performance data, theoretical assumptions or any combination thereof.

If, for example, adaptive decision engine 20 implements a linear regression algorithm, it will learn during training the relationship between each loan characteristic and the target (low or high risk) associated with the entire credit application. In the case of a mortgage application, features such as “Length of Time in Residence”, “Debt-to-Income Ratio”, “Loan Term”, “Applicant's State”, etc. are weighted in relation to the target variable (low or high risk). If, for example, a higher “Debt-to-Income Ratio” correlates with a higher chance that the application is high risk, the linear regression algorithm will likely raise the coefficient associated with this feature during training so that, once deployed, the scores generated by adaptive decision engine 20 are higher whenever a high “Debt-to-Income Ratio” is encountered.

Adaptive decision engine 20 can learn both on-line and off-line. That is, decision engine 20 may adapt and learn based on data currently being processed on-line, and may also be “tuned” off-line based on historical data and model parameters. So, engine 20 may be tuned off-line based on historical data and model parameters and then applied to current real-time data in an on-line environment.

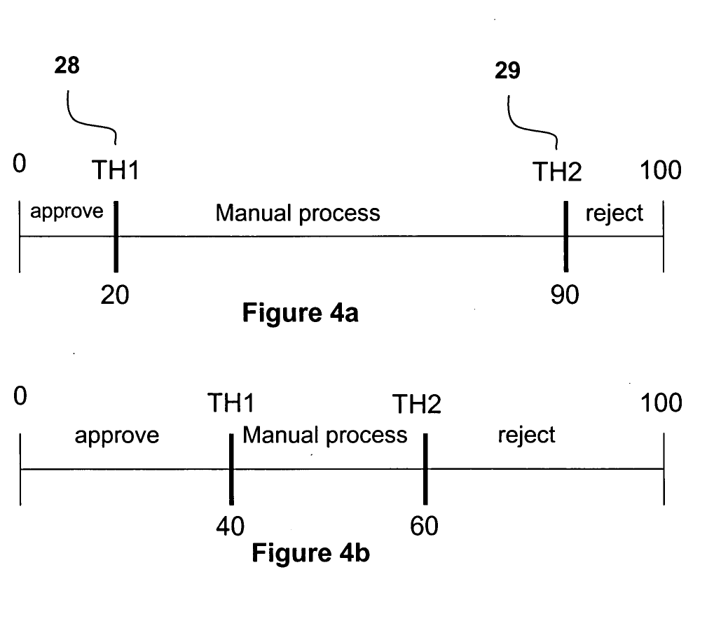

Using these methods, adaptive decision engine 20 produces a score that varies depending on the perceived risk associated with a credit application. For example, if the risk score is a value between 0 (low risk) and 100 (high risk), a threshold TH1 (28) for automatically approving loans can be set to, for example, 20 (FIG. 4a). In this case, if an application has a risk score of 10, it is automatically approved. As seen in FIG. 4b, the lender can set the risk threshold for automatic approval even higher, in which case a larger portion of applications will be automatically approved.

Applications with a risk score greater than the threshold TH1 are referred to loan officer 22 for manual review and decision to either approve or reject the application. Through use of adaptive decision engine 20 and risk thresholds, however, the number of loans that must be manually processed by loan officer 22 is much smaller than in current systems.

A second threshold TH2 (29) may also be set to automatically reject credit applications exceeding TH2. This threshold is useful to eliminate high risk credit applications which loan officer 22 does not need to waste time to consider. In FIG. 4a, for example, threshold TH2 is configured at 90. Over time, this could be reduced (FIG. 4b ), narrowing the window of applications that must be processed manually by loan officer 22.

TH1 and TH2 may be set to the same value, so that all loans are either approved or rejected automatically. This eliminates the need for manual processing and allows processing of all credit applications in real time. Such a configuration is ideal for Internet-based implementations where applications are submitted online, and can be used by brokers (business-to-business transactions, also known as “wholesale” or “correspondent lending” in the mortgage industry) as well as credit applicants (business-to-consumer model, also known as “retail”). Because of the immediate response to a submitted credit application, this real time system will have excellent usability and high user acceptance.

The present invention embraces implementations of adaptive decision engine 20 using TH1 only, TH2 only, or both TH1 and TH2. In addition, decision engine 20 may be placed before rules system 18 in the workflow. The decision engine result would then be submitted as additional input to rules system 18 and facilitate risk-based exception handling in a similar fashion.

One advantage of the present invention is that rules system 18 and adaptive decision engine 20 can give immediate feedback to broker 14, who will then know immediately whether a loan is approved or rejected. The only time delay occurs when manual processing is needed.

The decision to approve or reject a credit application can be based solely on risk score (as calculated by adaptive decision engine 20) or on a combination of risk score and total number of exceptions. For example, an application may be rejected if it contains an excessive number of exceptions according to rules system 18, even if it has a relatively low risk according to adaptive decision engine 20.

In another embodiment, a lender may not have a rules system 18 and may use adaptive decision engine 20 solely to determine whether credit applications should be approved or rejected. In this case, adaptive decision engine 20 is trained with historical credit data applicable to a specific loan product. A variant of this situation could be a simplified rules system in combination with decision engine 20.

Other embodiments and implementations of the invention will be or will become apparent to one of ordinary skill in the art. All such additional embodiments and implementations are within the scope of the invention as defined by the accompanying claims.

1. A system for processing credit applications comprising a computer-implemented adaptive decision engine that produces a score determined by the risk associated with a credit application.

2. A system as claimed in claim 1, wherein the credit application is automatically approved if the score is below a threshold TH1, and is referred for manual processing if the score is above the threshold TH1.

3. A system as claimed in claim 1, wherein the credit application is automatically rejected if the score is above a threshold TH2, and is referred for manual processing if the score is below the threshold TH2.

4. A system as claimed in claim 1 wherein the credit application is automatically approved if the score is below a threshold TH1, is automatically rejected if the score is above a threshold TH2, and is referred for manual processing if the score is between the thresholds TH1 and TH2.

5. A system as claimed in claim 4, wherein TH1=TH2 so that all credit applications are either automatically approved or rejected.

6. A system as claimed in claim 4, and further comprising a computer-implemented rules system that automatically approves the application if all conditions are met, and refers the application to the adaptive decision engine for further risk assessment if conditions are not met.

7. A system as claimed in claim 6, wherein the rules system generates a number of exceptions, and wherein a decision to approve or reject the credit application is based on the score generated by the adaptive decision engine in combination with the number of exceptions generated by the rules system.

8. A system as claimed in claim 6, wherein the rules system is incorporated in the adaptive decision engine.

9. A system as claimed in claim 1, wherein the adaptive decision engines uses a method selected from a group comprising neural networks, statistical algorithms and fuzzy logic to compute the score.

10. A system as claimed in claim 1, wherein the credit application is for a loan product selected from a group comprising a mortgage loan, an automobile loan, a home equity line of credit, a line of credit and a credit card.

11. A method for processing credit applications comprising:
calculating a risk score associated with a credit application; and
automatically approving or rejecting the credit application based on a comparison of the risk score with at least one predetermined threshold.

12. A method as claimed in claim 11, wherein all credit applications are either automatically approved or rejected.

13. A method as claimed in claim 11, wherein the credit application is referred for manual processing if the comparison of the risk score to the at least one predetermined threshold does not result in automatic approval or rejection of the application.

14. A method as claimed in claim 13, wherein the credit application is automatically approved if the risk score is less than a first threshold, is automatically rejected if the risk score is more than a second threshold, and is referred for manual processing if the risk score is between the first and second thresholds.

15. A method as claimed in claim 11, and further comprising:
automatically approving an application if it meets all conditions defined by a rules system;
generating exceptions if the application does not meet all conditions defined by a rule system.

16. A method as claimed in claim 15, wherein a decision to approve or reject the application is based on a combination of the risk score and the number of exceptions generated.

17. A computer program product stored in a tangible computer-readable medium and comprising:
an adaptive decision engine that produces a score determined by the risk associated with a credit application; and
a rules system that automatically approves the credit application if all conditions are met, and refers the application to the adaptive decision engine for further risk assessment if all conditions are not met.

18. A computer program product as claimed in claim 17, wherein the credit application is automatically approved if the score is below a threshold TH1, is automatically rejected if the score is above a threshold TH2, and is referred for manual processing if the score is between the thresholds TH1 and TH2.

19. A computer program product as claimed in claim 17, wherein a decision to approve or reject the credit application is based on the score generated by the adaptive decision engine in combination with a number of exceptions generated by the rules system for conditions that are not met.

20. A computer program product as claimed in claim 17, and further comprising:
means for electronically accepting and processing the credit applications from a credit applicant or a broker.
